(19) United States
(12) Patent Application Publication
(10) Pub. No.: US 2012/0103967 A1
(43) Pub. Date: May 3, 2012

(54) Burn-in oven having inverter fan and heat regulator

(75) Inventors: Yung-Tsung Hsu, Hsinchu (TW); Yen-Chang Liu, Hsinchu (TW); Ta Kang Liu, Hsinchu (TW)

(73) Assignee: King Yuan Electronics Co., Ltd., Hsinchu (TW)

(21) Appl. No.: 13/067,430

(22) Filed: Jun. 1, 2011

(30) Foreign Application Priority Data
Nov. 2, 2010 (TW) 099221157

(51) Int. Cl. A21B 1/22

(52) U.S. Cl. 219/400

(57) ABSTRACT

A burn-in oven having an inverter fan and a heat regulator includes a housing, a frame, a heater, a temperature sensor, an inverter fan, and a control unit. The housing includes an air-in port and an air-out port. The frame is fixedly arranged inside the housing, and is divided into a variety of partitions. In addition, the heater and the temperature sensor are also fixedly arranged inside the housing. The inverter fan is provided for supplying a forced air-flow toward inside of the housing. The control unit is electrically connected with the temperature sensor, the heater, and the inverter fan. The control unit is provided for controlling the temperature inside the housing not to exceed a predetermined value. Thereby, the present invention saves energy and shortens effectively the time required for burn-in temperature rising and lowering, and saves working hours and manpower as well.

### BACKGROUND OF THE INVENTION

1. Field of the Invention

The present invention relates to a burn-in oven, and more particularly, to a burn-in oven having an inverter fan and a heat regulator.

2. Description of Related Art

Certain electronic components or chip packages, such as integrated circuits (IC), are quite often installed, in a form of compact-size electronic components, in circuits consisting of electronic components, so that a continuous complete circuit can be established. To assure reliability of IC modules during use thereof, the IC modules have to be undertaken a burn-in test prior to being installed or used. In other words, to proceed with a high-temperature operation to the IC modules for a long time will make defective IC modules failed as soon as possible so as to screen and eliminate the defective IC modules. This process is referred to as a “burn-in test.”

Currently a conventional burn-in oven for IC modules, in the premise of raising production capacity, is aimed toward developing large quantities, namely, to arrange a great number of testing slots in a single burn-in oven. For a conventional burn-in oven, when testing IC modules, the cooling measure adopted inside the oven uses only a motor running, at a fixed rotational speed, for a long time so as to achieve the purpose of cooling. Such a measure will make energy wasted, because the motor inside the oven needs to run for long hours. And this is wasteful for energy.

Further, the heater arranged in the conventional burn-in oven adopts a common On-Off toggle switch, and that the heater runs continuously for hours such that a fixed heating temperature can be maintained, resulting in an energy waste. This is surely unsatisfactory, and there is still room for improvement. Therefore, a “burn-in oven having an inverter fan and a heat regulator,” according to the present invention, has been accomplished after research and repeated experiments.

### SUMMARY OF THE INVENTION

A primary object of the present invention is to provide a burn-in oven having an inverter fan and a heat regulator, so that energy can be saved, time required for temperature rising or temperature lowering be shortened effectively, and time and manpower saved.

To achieve the object, the burn-in oven having an inverter fan and a heat regulator, according to the present invention, comprises a housing, a frame, a heater, a temperature sensor, an inverter fan, and a control unit. The housing includes an air-in port and an air-out port. The frame is fixedly arranged inside the housing, and is divided into a variety of partitions for receiving a variety of IC modules. In addition, the heater and the temperature sensor are also fixedly arranged inside the housing. The inverter fan is provided for supplying a forced air-flow toward inside of the housing. The control unit is electrically connected with the temperature sensor, the heater, and the inverter fan. The control unit is provided for controlling the temperature inside the housing not to exceed a predetermined value.

Further, according to the present invention, the control unit may include a programmable logic controller (PLC), or other equivalents, so as to allow a tester to key in, promptly, frequency of the inverter fan and to maintain a uniform temperature in the oven.

Besides, the control unit may include a silicon controlled rectifier (SCR) electric heating regulator, so that the tester can adjust output power of the heater promptly so as to maintain a uniform temperature inside the oven.

The housing may further include a cooling-air inlet, where the cooling-air inlet is communicated with a cooling-air supply, so that the temperature in the oven can be lowered rapidly during a temperature-lowering process in the oven, and this will save time and manpower.

The burn-in oven having an inverter fan and a heat regulator, according to the present invention, may further comprise a temperature display fixedly arranged outside the housing for displaying temperature inside the housing.

The burn-in oven having an inverter fan and a heat regulator may further comprise an alarm fixedly provided outside the housing. In case the temperature inside the oven exceeds a predetermined value, the alarm will provide an alerting function, and if the temperature inside the oven does not exceed the predetermined value, the alarm will serve to display a normal condition.

According to the present invention, the heater may be fixedly provided above the plural partitions, and that the partitions may each be fixedly provided with a temperature sensor electrically connected with the control unit, namely the partitions in the oven are each provided with a temperature sensor, so as to precisely control testing temperature of each to-be tested IC module. In case the testing temperature of a to-be tested IC module exceeds the predetermined value, an alerting function can be provided so as to control the heater to lower down the temperature, and to prevent the to-be tested IC module from being damaged.

Further, according to the present invention, the partitions are each, at one side thereof, provided with an auxiliary fan electrically connected with the control unit such that a uniform temperature in the oven can be achieved rapidly. In addition, the plural auxiliary fans may each be an inverter fan, and be controlled by the control unit in respect of frequencies.

Other objects, advantages, and novel features of the present invention will become more apparent from the following detailed descriptions when taken in conjunction with the accompanying drawings.

### BRIEF DESCRIPTION OF THE DRAWINGS

FIG. 1 is a perspective view illustrating a burn-in oven having an inverter fan and a heat regulator according to a first embodiment of the present invention;

FIG. 2 is a front view illustrating the burn-in oven having an inverter fan and a heat regulator according to the first embodiment of the present invention;

FIG. 3 is a partial cross-sectional side view illustrating the burn-in oven having an inverter fan and a heat regulator according to the first embodiment of the present invention, when a cooling-air inlet is opened;

FIG. 4 is a partial cross-sectional side view illustrating the burn-in oven having an inverter fan and a heat regulator according to the first embodiment of the present invention, when the cooling-air inlet is closed;

FIG. 5 is a front view illustrating a burn-in oven having an inverter fan and a heat regulator according to a second embodiment of the present invention;

FIG. 6 is a front view illustrating a burn-in oven having an inverter fan and a heat regulator according to a third embodiment of the present invention;

FIG. 7 is a block diagram illustrating a systematic structure of the burn-in oven having an inverter fan and a heat regulator according to the first embodiment of the present invention;

FIG. 8 is a block diagram illustrating a systematic structure of the burn-in oven having an inverter fan and a heat regulator according to the second embodiment of the present invention; and

FIG. 9 is a block diagram illustrating a systematic structure of the burn-in oven having an inverter fan and a heat regulator according to the third embodiment of the present invention.

### DETAILED DESCRIPTION OF THE PREFERRED EMBODIMENTS

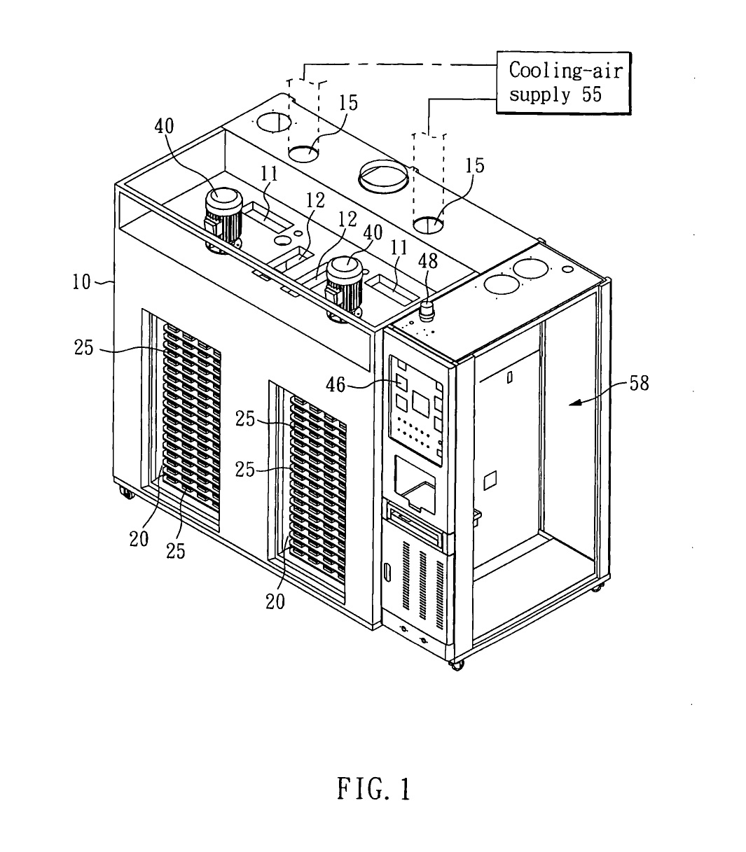

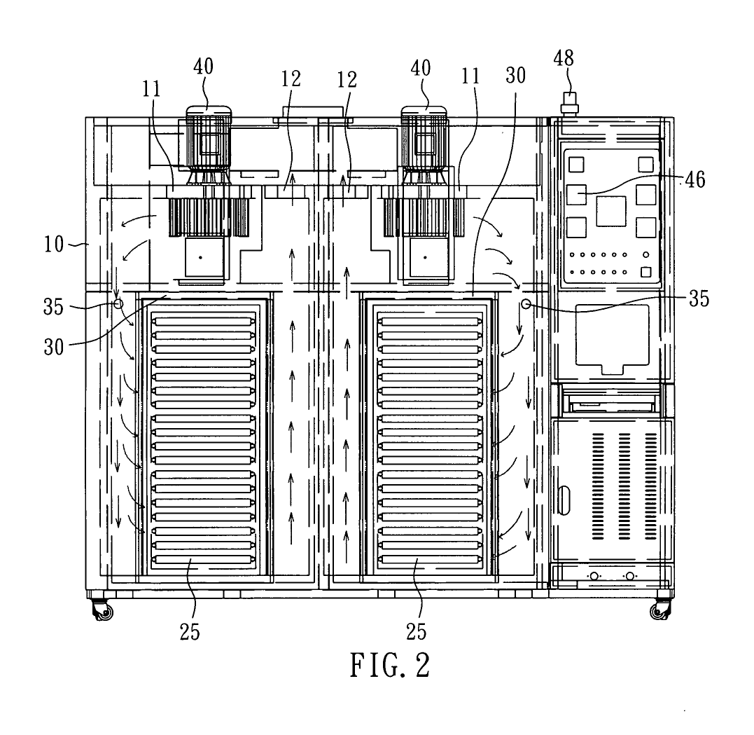

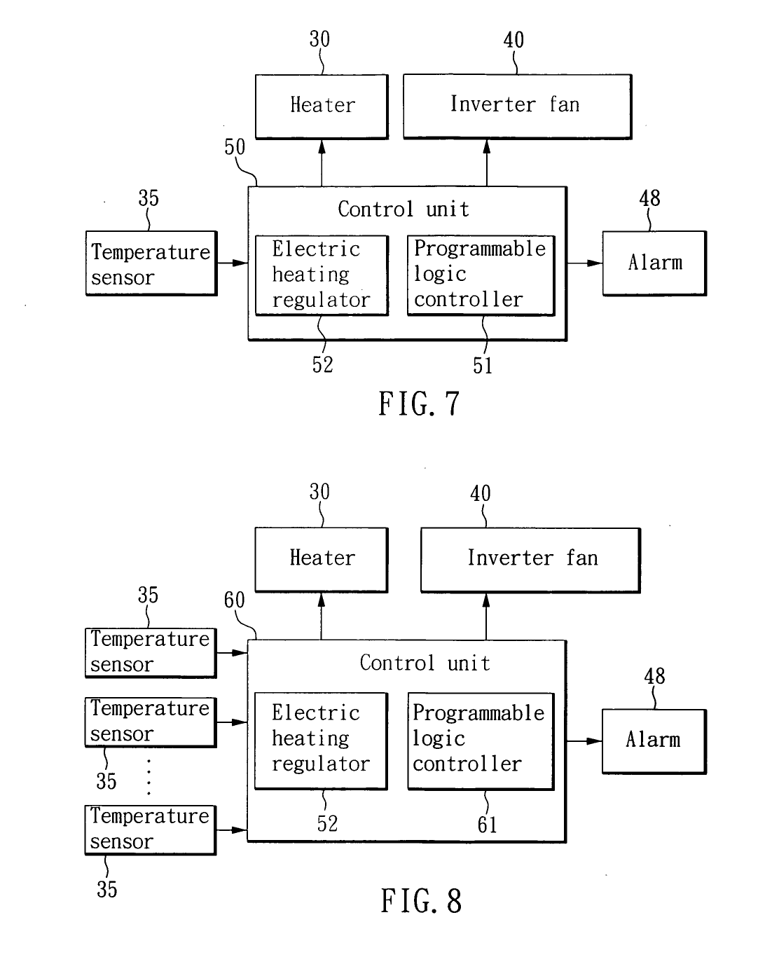

Referring to FIG. 1, a perspective view illustrating a burn-in oven having an inverter fan and a heat regulator according to a first embodiment of the present invention, to FIG. 2, a front view illustrating the burn-in oven, and to FIG. 7, a block diagram illustrating a systematic structure of the burn-in oven, the burn-in oven having an inverter fan and a heat regulator comprises a housing 10, a frame 20, a heater 30, a temperature sensor 35, an inverter fan 40, a temperature display 46, an alarm 48, a control unit 50, and a cooling-air supply 55.

As shown in FIG. 1, there is only one burn-in oven exemplified for description, though there are in fact two burn-in ovens with identical structures provided in the present embodiment. The housing 10 includes an air-in port 11, an air-out port 12, and a cooling-air inlet 15, where the cooling-air inlet 15 is communicated with the cooling-air supply 55. The housing 10 is fixedly provided, inside, with the frame 20 such that the frame 20 is divided into a variety of partitions 25, and that each partition 25 receives a to-be-tested IC module. In addition, the housing 10 is also fixedly provided, inside, with the heater 30 and the temperature sensor 35. The inverter fan 40 is fixedly provided on the housing 10 for supplying a forced air-flow of various strength toward inside of the housing 10. The alarm 48 is fixedly provided outside the housing 10. In case the temperature inside the oven exceeds a predetermined value, the alarm 48 will serve an alerting function, and if the temperature inside the oven does not exceed the predetermined value, the alarm 48 will serve to display a normal condition.

In the present embodiment, the heater 30 is fixedly provided above the plural partitions 25, with the temperature sensor 35 disposed closely to the heater 30 for measuring the temperature inside the housing 10. Further, the temperature display 46 is fixedly arranged on a dashboard located outside the housing 10 for displaying the temperature inside the housing 10. In addition, the alarm 48 relates to an alerting light, where a red light indicates that the temperature inside the housing 10 has exceeded the predetermined value and that the temperature is too high; whereas a green light indicates that the temperature inside the housing 10 does not exceed the predetermined value and thus is within a range of safety.

As shown in FIG. 7, the control unit 50 is electrically connected with the temperature sensor 35, the heater 30, and the inverter fan 40. The control unit 50, through controlling the output power of the heater 30 and the inverter fan 40 simultaneously, can control the temperature inside the housing 10 not to exceed the predetermined value.

In the present embodiment, the control unit 50 includes a programmable logic controller (PLC) 51 so as to allow a tester to key in, promptly, frequency of the inverter fan 40 and to maintain a uniform temperature in the oven. Besides, the control unit 50 also includes a silicon controlled rectifier (SCR) electric heating regulator 52, so that the tester can adjust the output power of the heater 30 promptly so as to maintain a uniform temperature inside the oven. Further, the control unit 50 is fixedly arranged inside a power distribution box 58.

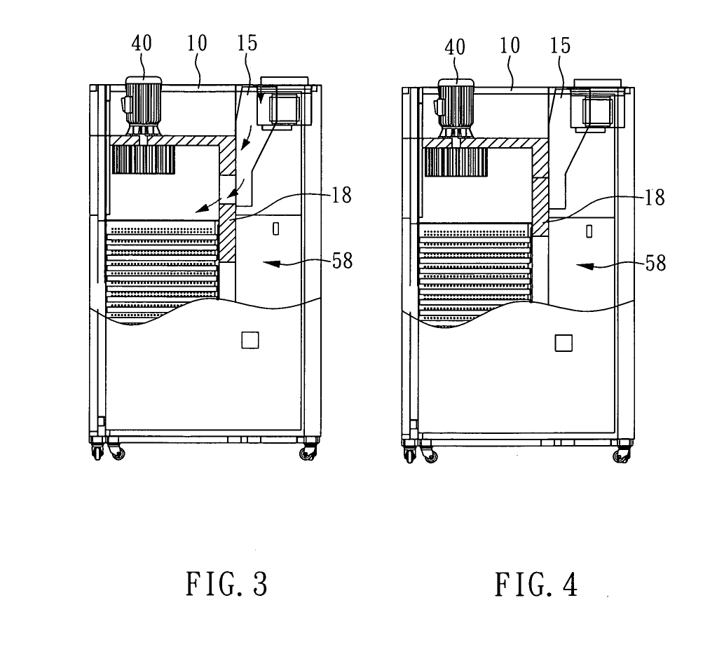

Further referring to FIG. 3, a partial cross-sectional side view illustrating the burn-in oven having an inverter fan and a heat regulator according to the first embodiment of the present invention when the cooling-air inlet is opened, and to FIG. 4, a partial cross-sectional side view illustrating the burn-in oven when the cooling-air inlet is closed, generally speaking, in testing temperature inside the housing 10, the heater 30 is employed to heat, rapidly, the oven from room temperature to an objective temperature of predetermined value. Then the temperature of the predetermined value is maintained constantly for a certain time, and thereafter, the temperature is lowered down to the room temperature. This will constitute a temperature testing cycle. During a stage of temperature rising, the heater 30 is controlled and adjusted to a maximum-output power heating. Whereas at a stage of constant temperature, the heater 30 is adjusted to lower down the output power, and that frequency of the inverter fan 40 is controlled so as to maintain a uniform temperature in the oven. During the temperature-rising and temperature-constant stages, as shown in FIG. 4, a cooling-air gate 18 is closed so as to avoid entrance of cooling air from outside and affecting the heating. As to the temperature-lowering stage, as shown in FIG. 3, the cooling-air gate 18 is opened, so that the cooling-air can be introduced from outside, and that the cooling time can be shortened.

Thereby, the present embodiment runs more effectively than a conventional fan motor, and this saves energy and shortens effectively the time required for burn-in temperature rising and lowering. As such, working hours and manpower can be saved.

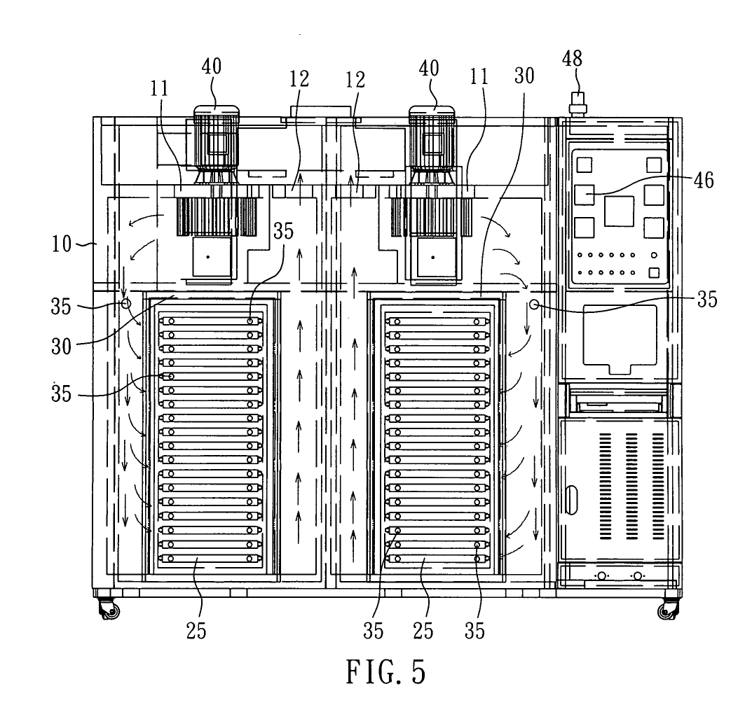

Now referring to FIG. 5, a front view illustrating a burn-in oven having an inverter fan and a heat regulator according to a second embodiment of the present invention, and to FIG. 8, a block diagram illustrating a systematic structure of the burn-in oven, this embodiment is substantially similar to the first embodiment in terms of structure, except that in the second embodiment, the partitions 25 are each provided with a temperature sensor 35 which is electrically connected with a control unit 60. In addition, a programmable logic controller 61 is provided for changing the frequency of the inverted fan 40 in response to various temperatures measured through the plural temperature sensors 35.

Therefore, it is understood that like the first embodiment, in addition to having merits in saving energy, effectively shortening time required for burn-in temperature rising and temperature lowering, and saving working hours and manpower, the second embodiment can also precisely control testing temperature of each to-be tested IC module. In case the testing temperature of a to-be tested IC module exceeds the predetermined value, an alerting function can be provided so as to control the heater 30 to lower down the temperature, and to prevent the to-be tested IC module from being damaged.

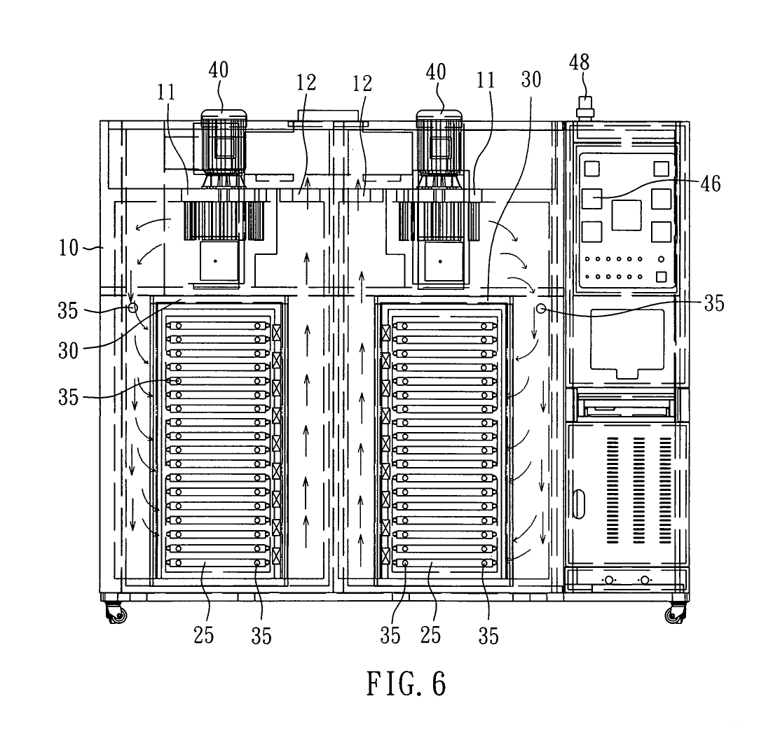

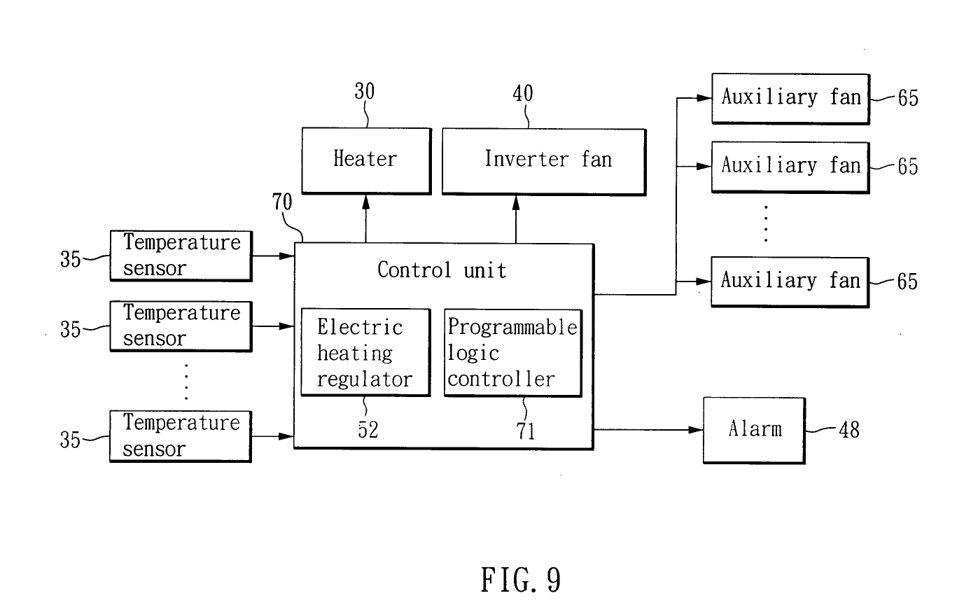

Further referring to FIG. 6, a front view illustrating a burn-in oven having an inverter fan and a heat regulator according to a third embodiment of the present invention, and to FIG. 9, a block diagram illustrating a systematic structure of the burn-in oven, this embodiment is substantially similar to the second embodiment in terms of structure, except that in the third embodiment, the partitions 25 are each, at one side thereof, provided with an auxiliary fan 65 which is electrically connected with a control unit 70. In the third embodiment, the plural auxiliary fans 65 are all related to inverter fans 65, and are each controlled by the control unit 70 in respect of frequencies. Likewise, a programmable logic controller 71 is provided for changing the frequencies of the inverted fan 40 and the auxiliary fans 65 in response to various temperatures measured through the plural temperature sensors 35.

As such, like the second embodiment, in addition to having merits in saving energy, effectively shortening time required for burn-in temperature rising and temperature lowering, and saving working hours and manpower, the third embodiment can also precisely control testing temperature of each to-be tested IC module. In case the testing temperature of a to-be tested IC module exceeds the predetermined value, an alerting function can be provided so as to control the heater 30 to lower down the temperature, and to prevent the to-be tested IC module from being damaged. Moreover, in the third embodiment, with the help of the auxiliary fans 65, the temperature in the oven can reach to uniformity more rapidly.

Although the present invention has been explained in relation to its preferred embodiments, it is to be understood that many other possible modifications and variations can be made without departing from the scope of the invention as hereinafter claimed.

What is claimed is:

1. A burn-in oven having an inverter fan and a heat regulator, comprising:
a housing, including an air-in port and an air-out port;
a frame, being fixedly arranged inside the housing, and being divided into a variety of partitions;
a heater, being fixedly arranged inside the housing;
a temperature sensor, being fixedly arranged inside the housing;
an inverter fan, being provided for supplying a forced air-flow toward inside the housing; and
a control unit, being electrically connected with the temperature sensor, the heater, and the inverter fan for controlling temperature inside the housing not to exceed a predetermined value.

2. The burn-in oven having an inverter fan and a heat regulator as claimed in claim 1, wherein the control unit includes a programmable logic controller (PLC).

3. The burn-in oven having an inverter fan and a heat regulator as claimed in claim 1, wherein the control unit includes a silicon controlled rectifier (SCR) electric heating regulator.

4. The burn-in oven having an inverter fan and a heat regulator as claimed in claim 1, further comprising a plurality of auxiliary fans electrically connected with the control unit, wherein each auxiliary fan is fixedly arranged at one side of each partition.

5. The burn-in oven having an inverter fan and a heat regulator as claimed in claim 1, further comprising a temperature display fixedly arranged outside the housing for displaying temperature inside the housing.

6. The burn-in oven having an inverter fan and a heat regulator as claimed in claim 1, further comprising an alarm fixedly provided outside the housing to provide an alerting function if the temperature inside the oven exceeds a predetermined value.

7. The burn-in oven having an inverter fan and a heat regulator as claimed in claim 1, wherein the heater is fixedly provided above the plural partitions.

8. The burn-in oven having an inverter fan and a heat regulator as claimed in claim 1, wherein the partitions are each be fixedly provided with a temperature sensor electrically connected with the control unit.

9. The burn-in oven having an inverter fan and a heat regulator as claimed in claim 1, further comprising a cooling-air inlet communicated with a cooling-air supply.
